(19) United States
(12) Patent Application Publication
(10) Pub. No.: US 2014/0132832 A1
(43) Pub. Date: May 15, 2014

(54) MOBILE DEVICE CAMERA ENCLOSURE

(71) Applicants: William Adams, Beverly Hills, CA (US); Chandrasekar Rathakrishnan, Singapore (SG)

(72) Inventors: William Adams, Beverly Hills, CA (US); Chandrasekar Rathakrishnan, Singapore (SG)

(73) Assignee: I.AM.SYMBOLIC, LLC, Beverly Hills, CA (US)

(21) Appl. No.: 14/074,605

(22) Filed: Nov. 7, 2013

Related U.S. Application Data
(60) Provisional application No. 61/724,675, filed on Nov. 9, 2012.

(51) Int. Cl. H04N 5/225; G06F 3/02

(52) U.S. Cl. CPC H04N 5/2254; G06F 3/02
USPC 348/376

(57) ABSTRACT

Embodiments extend to mobile device enclosures that enhance the image capture abilities of mobile devices and that improve user experience when using a mobile device as a camera. In one case, a mobile device enclosure is configured to attach to a mobile device. The mobile device enclosure includes a lens mount that is configured to position a lens over a camera of the mobile device. The mobile device enclosure also includes a battery that is configured to provide power to the mobile device, and a slide-out keyboard that is configured to provide textual input information to the mobile device.

### CROSS-REFERENCE TO RELATED APPLICATIONS

This application claims priority to and the benefit of U.S. Provisional Application Ser. No. 61/724,675, entitled “Mobile Device Camera Enclosure”, filed on Nov. 9, 2012, which application is incorporated by reference in its entirety herein.

### BACKGROUND

The recent proliferation of mobile computing devices, such as smartphones, digital media players, and tablet computers has been astounding. Mobile computing devices have become an integral part of modern life, and are now possessed by a significant portion of the population. As mobile computing devices have evolved, they have become capable of performing significant computing tasks, such as image and video processing/editing, capturing high-resolution digital images and movies, and communication of digital images and movies to other electronic devices. As the computing ability of mobile computing devices has evolved, so has the quality of their images sensors and optics. As such, mobile computing devices can now capture, process, and share very high quality digital imagery.

### BRIEF SUMMARY

Embodiments described herein extend to mobile device enclosures that enhance the image capture abilities of mobile devices and that improve user experience when using a mobile device as a camera. In one embodiment, a mobile device enclosure is configured to attach to a mobile device. The mobile device enclosure includes a lens mount that is configured to position a lens over a camera of the mobile device. The mobile device enclosure also includes a battery that is configured to provide power to the mobile device, and a slide-out keyboard that is configured to provide textual input information to the mobile device.

In another embodiment, a camera system is provided. The camera system includes a mobile communications device that includes a camera. The camera system further includes a mobile communications device enclosure that is removably attached to the mobile communications device. The mobile device enclosure includes a lens that is positioned over the camera of the mobile communications device, a shutter mechanism, a battery that is configured to charge the mobile communications device and a slide-out keyboard. The mobile device enclosure is configured to communicate to the mobile communications device an identity of the lens, textual input that is received at the slide-out keyboard and/or shutter triggering information that is received at the shutter mechanism.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A illustrates a top, front, back, side, and bottom view of a mobile device enclosure, according to one or more embodiments of the present invention.

FIG. 1B illustrates a front view of a mobile device enclosure, according to one or more embodiments of the present invention.

FIG. 1C illustrates a perspective view of a mobile device enclosure, according to one or more embodiments of the present invention, which depicts the front and top of the mobile device enclosure.

FIG. 1D illustrates a perspective view of a mobile device enclosure, according to one or more embodiments of the present invention, which depicts the front, top, and a side of the mobile device enclosure.

FIG. 1E illustrates a perspective view of a mobile device enclosure, according to one or more embodiments of the present invention, which depicts the back and top of the mobile device enclosure.

FIG. 1F illustrates a back view of a mobile device enclosure, including a slide-out keyboard, according to one or more embodiments of the present invention.

FIG. 1G illustrates a back view of a mobile device enclosure, according to one or more embodiments of the present invention.

### DETAILED DESCRIPTION

Embodiments described herein extend to mobile device enclosures that enhance the image capture abilities of mobile devices and that improve the user experience when using a mobile device, such as smartphone or a tablet, as a camera. More particularly, the present invention extends to mobile device enclosures that enclose or otherwise attach to mobile devices, that position a lens over a camera of the attached mobile device, and that include a battery that provides power to the attached mobile device and a slide-out keyboard that can be used to provide textual input to the attached mobile device.

Mobile computing devices according to embodiments of the present invention can include multi-purpose mobile computing devices, such as smartphones, digital media players, tablet computers, etc. As used herein, multi-purpose mobile computing devices include the ability to be repurposed for various functions. For example, multi-purpose mobile computing devices may include (and/or provide the ability to have installed thereon) a plurality of applications (apps) that, when executed, repurpose the multi-purpose mobile computing device for different functions. As such, mobile computing devices can comprise general computing devices that can be re-purposed for different particular functionality through the use of different apps. In some embodiments, mobile computing devices comprise mobile communications devices that are also multi-purpose mobile computing devices.

Mobile device enclosures according to embodiments of the present invention may comprise enclosures that encompasses or otherwise contain a mobile computing device, such as a smartphone, a digital media player, tablet, laptop, etc. Mobile device enclosures may include a lens that is configured to be positioned over a camera of the mobile computing device that is being used in connection with the mobile device enclosure. As such, mobile device enclosures can enhance the image capturing capabilities of the mobile computing device. In some embodiments, a mobile device enclosure includes a lens mount, which enables a variety of different lenses to be removably attached to the mobile device enclosure. As such, mobile device enclosures according to embodiments herein can enable a variety of different lenses (e.g., telephoto, wide-angle, fish eye, zoom) to be used with mobile computing devices. In some embodiments, mobile device enclosures include a lens release mechanism that is configured to release an attached lens, when activated. In some embodiments, the lens mount may be enabled to provide power to an attached lens. For example, the lens mount may include an energy storage module such as a battery or other energy store. This energy storage module may then be attached to the mobile device (via either a wired or a wireless connection) and act as a primary or supplemental power source.

Mobile device enclosures according to embodiments described herein may be configured to communicate with a mobile computing device that is being used in connection with the mobile device enclosure. For example, a mobile device enclosure may be configured to interface with a hard-wired data port of the mobile computing device. Such a hard-wired data port may include a UNIVERSAL SERIAL BUS (“USB”) port, an APPLE DOCK CONNECTOR, an APPLE LIGHTNING port, and/or any other appropriate data port. Additionally or alternatively, a mobile device enclosure may be configured to interface with the mobile computing device wirelessly, such as through use of WIFI, BLUETOOTH, NEAR FIELD COMMUNICATIONS, or any other appropriate wireless communications mechanism.

Mobile device enclosures according to embodiments of the present invention may be configured to communicate information about an attached lens to a mobile computing device, and/or to receive lens-related instructions from the mobile computing device over a hard-wired or wireless communications mechanism. For example, mobile device enclosures may communicate lens identification information to the mobile computing device. The lens identification information may indicate the type or brand of lens in place, and may further indicate various features or characteristics of the lens. In another example, mobile device enclosures may communicate information about lens state (e.g., aperture, focus, zoom) to the mobile computing device. Based on received lens identification information, lens state information, etc., the mobile computing device may enable, disable, or otherwise modify software and/or hardware functionality. For instance, if the lens provides certain features unique to that lens or lens type, the mobile computing device may provide those features to a user. The mobile computing device may, for example, provide a user interface with various features for controlling the camera. These features may be varied depending on which type of lens is being used within the mobile device camera enclosure.

In addition, mobile device enclosures according to embodiments of the present invention may receive lens instructions (e.g., a desired aperture, focus, or zoom) from the mobile computing device. As such, the lens mount of a mobile device enclosure may be enabled for one- or two-way communications with an attached lens. For example, software at the mobile computing device may instruct the lens to achieve a particular aperture, zoom level, focus parameter, etc.

Mobile device enclosures according to embodiments herein may include other camera-related hardware devices. For example, mobile device enclosures can include one or more shutter mechanisms (e.g., buttons, touch-sensitive pads) that generate shutter trigger information when activated. In another example, mobile device enclosures can include one or more flash mechanisms that are configured to provide illumination during capture of an image. In yet another example, mobile device enclosures can include one or more light sensors that are configured to measure the intensity of ambient light and to generate light intensity information.

Mobile device enclosures according to embodiments described herein can be configured send and/or receive appropriate data relating to these hardware devices to a mobile computing device over a hard-wired and/or a wireless connection. For example, mobile device enclosures may send shutter trigger information to the mobile computing device when a shutter mechanism is activated, mobile device enclosures may send light intensity information to the mobile computing device as detected by a light sensor, and mobile device enclosures may receive a flash firing signal from the mobile computing device and fire a flash as appropriate.

Mobile device enclosures according to embodiments described herein may further include a slide-out keyboard having any appropriate key layout (e.g., QUERTY). As such, mobile device enclosures can be configured to provide textual input information to a mobile computing device over a hard-wired and/or a wireless connection. In some embodiments, mobile device enclosures include a keyboard release mechanism that is configured to release the slide-out keyboard when activated.

Mobile device enclosures according to embodiments described herein may also include one or more batteries that are configured to provide power to a mobile computing device that is being used in connection with the mobile device enclosure. As such, the one or more batteries can be used to charge the mobile computing device or to otherwise extend the battery life of the mobile computing device. Mobile device enclosures may provide power to mobile computing devices using a hard-wired connection (e.g., USB, APPLE DOCK CONNECTOR, APPLE LIGHTING), or though a wireless power-transfer mechanism (e.g., inductive charging). The one or more batteries may also be configured to provide power to a flash and/or to a lens that is included in, or attached to, the mobile device enclosure.

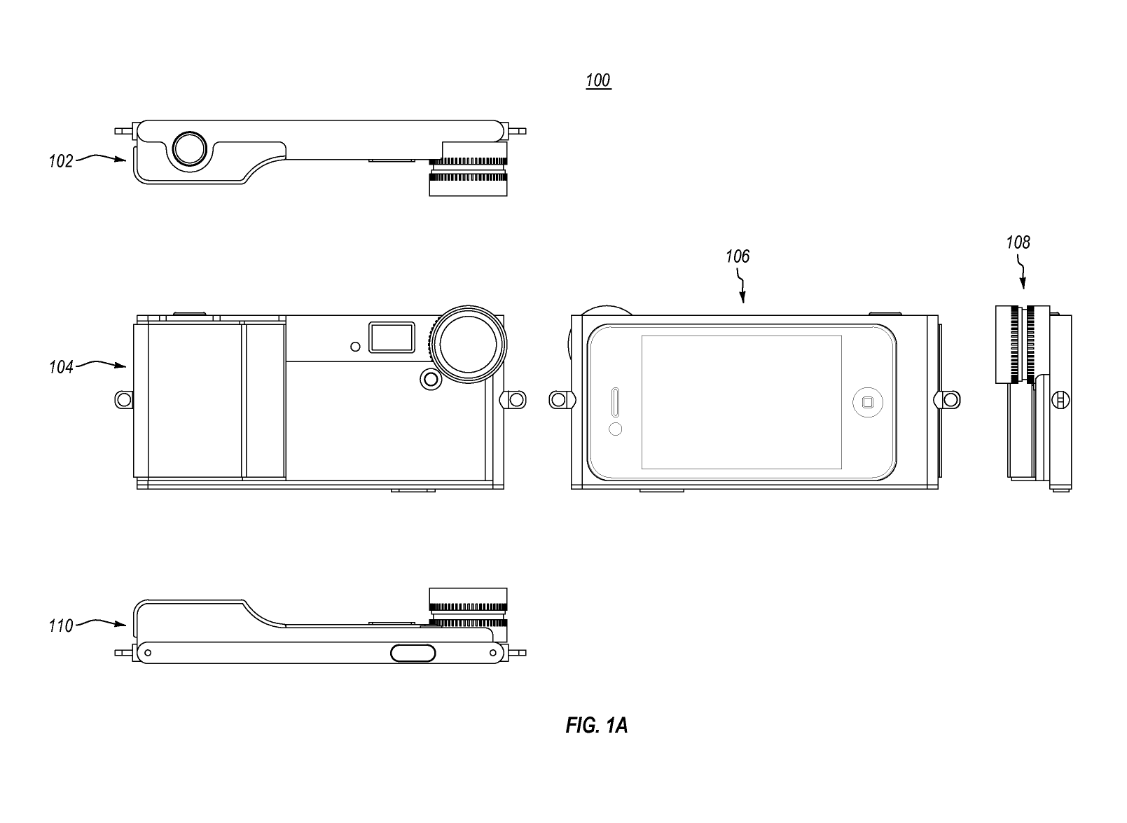

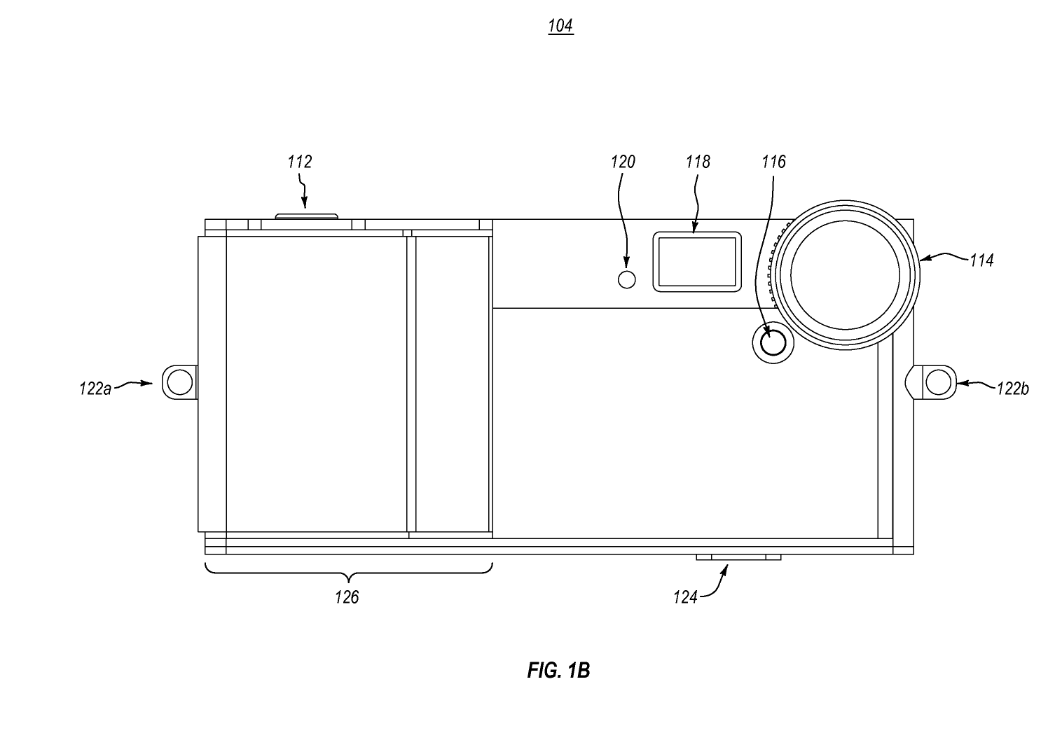

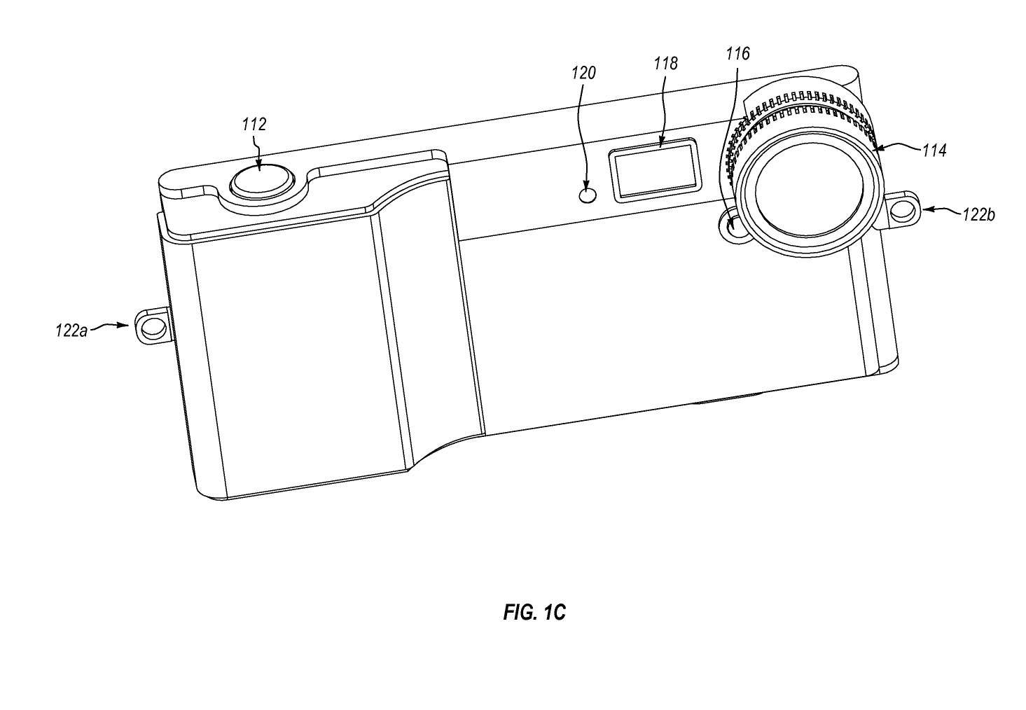

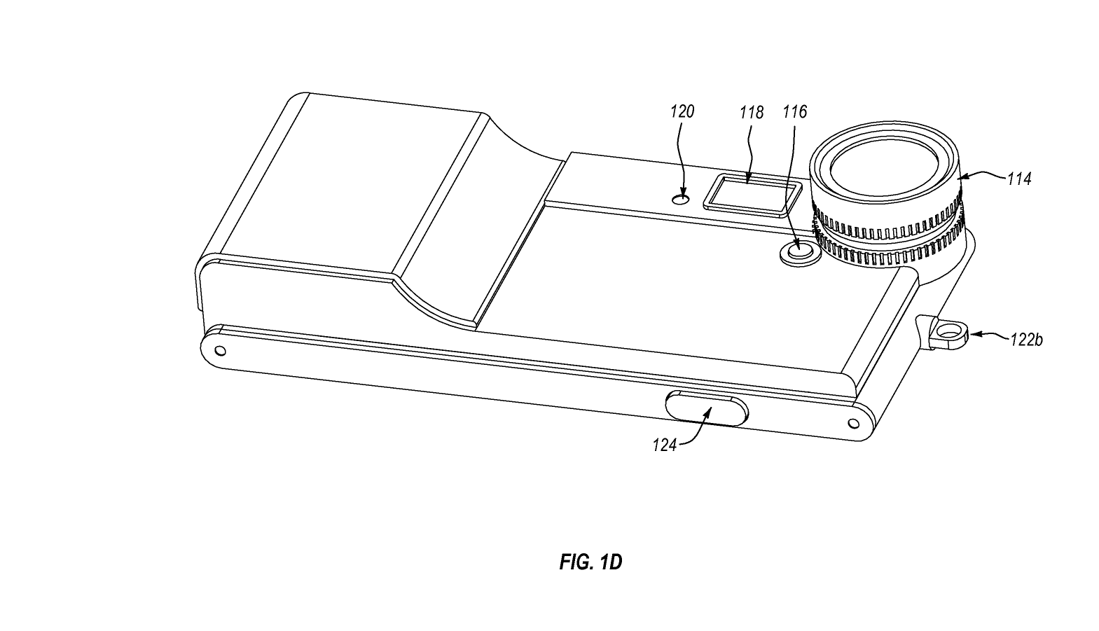

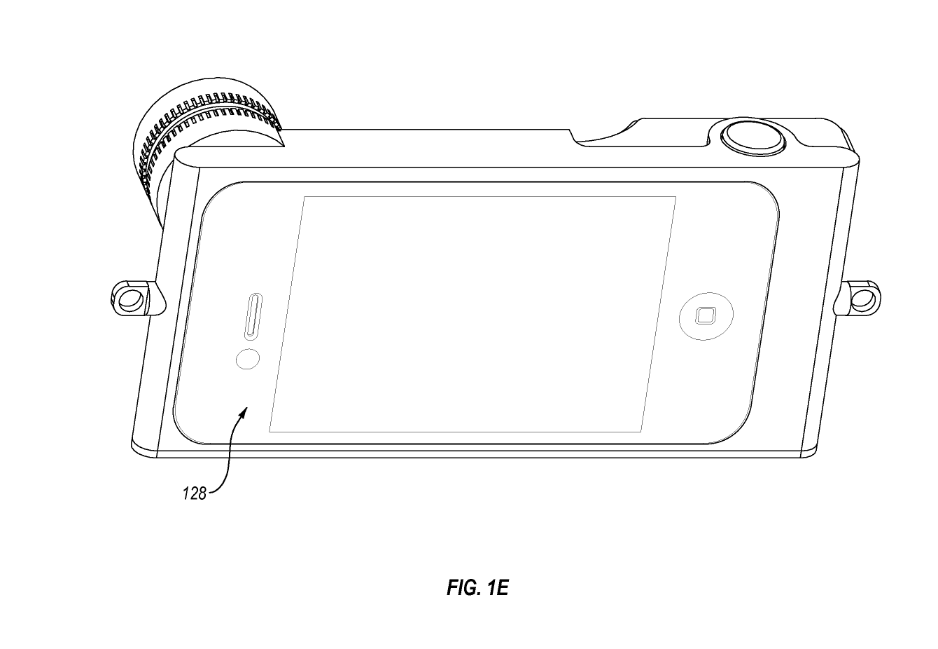

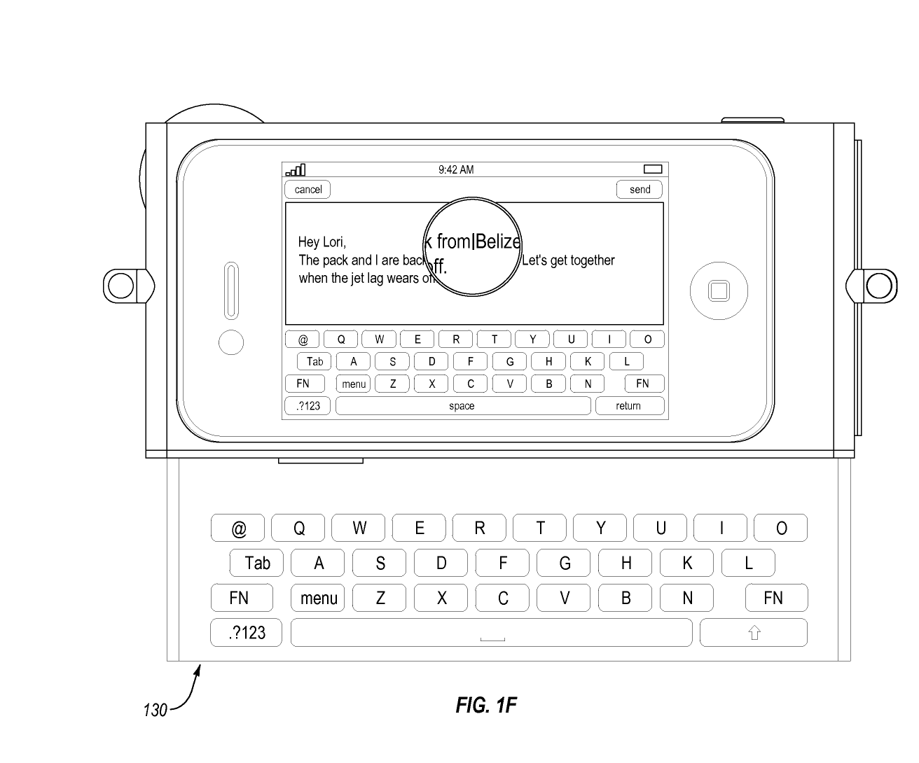

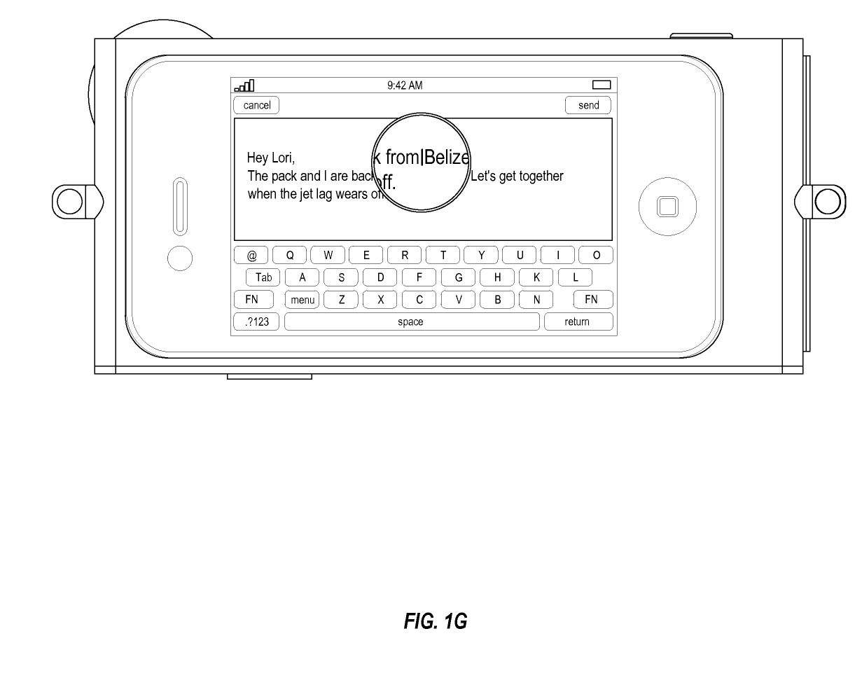

Mobile device enclosures according to embodiments described herein may aesthetically appear and function as a camera. Mobile device enclosures may comprise a variety of aesthetic forms and color schemes. For example, FIGS. 1A-1G illustrate an embodiment of a mobile device enclosure that appears as a modern classic camera design. Other embodiments may include a mobile device enclosure that appears as a “point and shoot” camera or other type of camera.

FIG. 1A depicts a top view 102, front view 104, back view 106, side view 108, and bottom view 110 of a mobile device enclosure 100, according to various embodiments. The mobile device enclosure is configured to appear as a modern classic camera design. The camera enclosure may be designed for one specific mobile computing device (e.g. smartphone), or for a specific brand of devices. Moreover, the camera enclosure 100 may be designed more generically to fit with multiple different brands and types of devices. The camera enclosure is designed to fit snugly around all or portions of the mobile device and, at least in some cases, is designed to optically align the camera enclosure's lens over the mobile device's camera. In this manner, different types of lenses may be used with the camera accessory which may provide different types of photographic functionality to the end user.

FIG. 1B depicts front view 104 of the mobile device enclosure 100 in greater detail. As depicted, mobile device enclosure 100 includes lens 114 and lens release mechanism 116, which is configured to release lens 114 from a lens mount (not shown) of mobile device enclosure 100, when activated. As mentioned above, mobile device enclosure 100 may be configured to align lens 114 over a camera of a mobile computing device that is being used in connection with mobile device enclosure 100. The lenses 114 may provide wide angle, fish eye or other lens effects to the mobile device's camera.

As depicted, the mobile device enclosure 100 also includes other camera-related hardware devices, such as a shutter mechanism 112, a light sensor 120, and a flash 118. In some embodiments, some camera-related hardware devices may be non-functional and, instead, be purely aesthetic. For example, light sensor 120 and flash 118 may not actually function as a light detection device or a flash device. As depicted, mobile device enclosure 100 may include other elements, such as one or more lanyard attachment mechanisms (122a, 122b) and a keyboard release mechanism 124.

Although not depicted, mobile device enclosure 100 can also include one or more batteries. For example, mobile device enclosure 100 may include a battery in a grip portion 126 of mobile device enclosure 100. Mobile device enclosure 100 may also include one or more power ports (not shown) for charging the one or more batteries.

FIGS. 1C and 1D depict additional front-oriented perspective views of mobile device enclosure 100, including additional views of shutter mechanism 112, lens 114, lens release mechanism 116, flash 118, light sensor 120, lanyard attachment mechanisms (122a, 122b), and keyboard release mechanism 124.

FIG. 1E illustrates a back-perspective view of the mobile device enclosure 100, and depicts a mobile computing device 128 (e.g., a smartphone, portable media device, etc.) being housed within mobile device enclosure 100. Mobile device enclosure 100 may include any appropriate mechanisms (e.g., clips) for securing mobile computing device 128 within mobile device enclosure 100. In some embodiments, mobile computing device 128 is secured within mobile device enclosure 100 using a hard-wired connection port (e.g., USB, APPLE DOCK CONNECTOR, APPLE LIGHTNING).

FIGS. 1F and 1G depict back views of mobile device enclosure 100, with a slide out keyboard 130 in an extended state (FIG. 1F) and in a retracted state (FIG. 1G). As depicted in FIG. 1F, slide out keyboard 130 can be used by a user to provide textual input to mobile computing device 128. The textual input can be provided to mobile computing device 128 using a hard-wired or wireless communications mechanism. Other input mechanisms (such as a stylus) may also be provided on the mobile device enclosure 100. Indeed, the features provided on the mobile device enclosure 100 may be rearranged in a variety of different manners to achieve a variety of different looks. Moreover, interchangeable inserts may be provided to add different color schemes or different patterns to the mobile device enclosure. This allows a user to personalize and customized their mobile device camera enclosure. At least in some embodiments, the mobile device may detect when it has been inserted in the mobile device enclosure, and may automatically display functionality corresponding thereto. For example, when a user inserts the mobile device into a mobile device enclosure, the mobile device may automatically display camera functionality to the user. Similarly, if the mobile device determines that a specific type of lens is being used with the mobile device enclosure, the mobile device may bring up a user interface that includes functions specific to that type of lens, or specific to the functionality provided by that mobile device camera enclosure.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware. These computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. A computing system may be distributed over a network environment and may include multiple constituent computing systems.

A computing system typically includes at least one processing unit and memory. The memory may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routings, or methods that may be executed on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system. Computing system may also contain communication channels that allow the computing system to communicate with other message processors over a wired or wireless network.

Embodiments described herein may comprise or utilize a special-purpose or general-purpose computer system that includes computer hardware, such as, for example, one or more processors and system memory, as discussed in greater detail below. The system memory may be included within the overall memory. The system memory may also be referred to as “main memory”, and includes memory locations that are addressable by the at least one processing unit over a memory bus in which case the address location is asserted on the memory bus itself. System memory has been traditional volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

Still further, system architectures described herein can include a plurality of independent components that each contribute to the functionality of the system as a whole. This modularity allows for increased flexibility when approaching issues of platform scalability and, to this end, provides a variety of advantages. System complexity and growth can be managed more easily through the use of smaller-scale parts with limited functional scope. Platform fault tolerance is enhanced through the use of these loosely coupled modules. Individual components can be grown incrementally as business needs dictate. Modular development also translates to decreased time to market for new functionality. New functionality can be added or subtracted without impacting the core system.

The concepts and features described herein may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed:

1. A mobile device enclosure that is configured to attach to a mobile device, comprising:
a lens mount portion of the mobile device enclosure that is configured to position a lens over a camera of the mobile device when the mobile device enclosure is attached to the mobile device;
a battery within the mobile device enclosure that is configured to provide power to the mobile device; and
a slide-out keyboard within the mobile device enclosure that is configured to provide textual input information to the mobile device.

2. The mobile device enclosure as recited in claim 1, wherein the mobile device enclosure is configured to aesthetically appear and function as a camera.

3. The mobile device enclosure as recited in claim 1, further comprising a shutter mechanism that provides shutter trigger information to the mobile device when activated.

4. The mobile device enclosure as recited in claim 1, further comprising a light sensor that provides light intensity information to the mobile device.

5. The mobile device enclosure as recited in claim 1, further comprising a flash that provides illumination in response to a flash firing signal from the mobile device.

6. The mobile device enclosure as recited in claim 1, further comprising a lens release mechanism that releases a lens that is attached to the lens mount when activated.

7. The mobile device enclosure as recited in claim 1, further comprising a lanyard attachment mechanism.

8. The mobile device enclosure as recited in claim 1, further comprising a keyboard release mechanism that is configured to release the slide-out keyboard when activated.

9. The mobile device enclosure as recited in claim 1, wherein the lens mount is configured to removably attach to one or more different lenses.

10. The mobile device enclosure as recited in claim 1, wherein the mobile device enclosure is configured to interface with the mobile device via one or more hard-wired connections.

11. The mobile device enclosure as recited in claim 1, wherein the mobile device enclosure is configured to interface with the mobile device via one or more wireless connections.

12. The mobile device enclosure as recited in claim 1, wherein the mobile device enclosure is configured to communicate lens identification information to the mobile device.

13. The mobile device enclosure as recited in claim 1, wherein the mobile device enclosure is configured to communicate one or more of aperture, focus, or zoom information with the mobile device.

14. The mobile device enclosure as recited in claim 1, wherein the mobile device enclosure is configured to provide power to the mobile device.

15. The mobile device enclosure as recited in claim 1, wherein the mobile device enclosure is configured to communicate at least one of the following to the mobile device: light intensity information, textual input information and shutter trigger information.

16. The mobile device enclosure as recited in claim 1, wherein the mobile device enclosure is configured to receive a flash firing signal from the mobile device.

17. A camera system, comprising:
a mobile communications device that includes a camera; and
a mobile communications device enclosure that is removably attached to the mobile communications device, wherein the mobile device enclosure includes:
a lens that is positioned over the camera of the mobile communications device;
a shutter mechanism;
a battery that is configured to charge the mobile communications device; and
a slide-out keyboard,
wherein the mobile device enclosure is configured to communicate at least one of the following to the mobile communications device:
an identity of the lens;
textual input that is received at the slide-out keyboard; and
shutter triggering information that is received at the shutter mechanism.

18. The camera system as recited in claim 17, wherein the mobile communications device comprises a multi-purpose mobile computing device.

19. A mobile device enclosure that is configured to attach to a mobile device, comprising:
a connection mechanism that is configured form a hard-wired connection with the mobile device;
a battery that is configured to charge the mobile device over the hard-wired connection;
a slide-out keyboard;
a shutter mechanism; and
a lens mount that is configured to connect to a lens and to position the lens over a camera of the mobile device,
wherein the mobile device enclosure is configured to communicate at least one of the following to the mobile device:
an identity of the lens that is connected to the lens mount;
textual input that is received at the slide-out keyboard; and
shutter triggering information that is received at the shutter mechanism.

20. The mobile device enclosure as recited in claim 19, wherein the mobile device enclosure is configured to communicate each of the identity of the lens that is connected to the lens mount, textual input that is received at the slide-out keyboard, and shutter triggering information that is received at the shutter mechanism to the mobile device.
